(19) United States
(12) Patent Application Publication
(10) Pub. No.: US 2011/0110424 A1
(43) Pub. Date: May 12, 2011

(54) Video Encoder and Data Processing Method

(75) Inventors: Nobuhiro Chihara, Kokubunji (JP); Masatoshi Kondo, Kodaira (JP); Muneaki Yamaguchi, Inagi (JP); Masaki Hamamoto, Kokubunji (JP); Takanobu Tsunoda, Kokubunji (JP)

(73) Assignee: Hitachi Kokusai Electric Inc., Tokyo (JP)

(21) Appl. No.: 12/944,282

(22) Filed: Nov. 11, 2010

(30) Foreign Application Priority Data
Nov. 12, 2009 (JP) 2009-258957

(51) Int. Cl. H04N 7/32

(52) U.S. Cl. 375/240.12; 375/E07.243

(57) ABSTRACT

A video encoder for evaluating a prediction error by using a prediction technique include: an image encoding section which encodes a prediction image; and an encoding control device which selects any one of a plurality of prediction modes in prediction used by the image encoding section. The image encoding section performs clipping of higher-order bits of the prediction error input to the encoding control device and reduction of lower-order bits thereof for each of the prediction modes to control prediction mode selection, thus reducing the prediction error bit width to a predetermined bit width. The encoding control device sets to the image encoding section the number of higher-order bits to be clipped and the number of lower-order bits to be reduced. The predetermined bit width of the prediction error after bit width reduction is matched with the bus width used for prediction error transmission by the encoding control device and the image encoding section.

Thus, the prediction error bit width can be reduced without degrading the prediction error accuracy so much.

### CLAIMS OF PRIORITY

The present application claims priority from Japanese patent application serial no. JP2009-258957, filed on Nov. 12, 2009, the content of which is hereby incorporated by reference into this application.

### BACKGROUND OF THE INVENTION

The present invention relates to a video encoder and a data processing method therefor. More particularly, the present invention relates to a video encoder capable of encoding a moving image by using a plurality of prediction modes without performance degradation by prediction error transmission, in particular, without degrading the prediction error accuracy in prediction error evaluation. The present invention also relates to a data processing method.

With the increase in video distribution content through the development of broadband networks as well as the popularization of mass storage media such as DVDs and large screen display devices, a video encoding technique has become essential. Further, with the achievement of a higher level gray-scale for imaging devices, the amount of information held by one pixel is increasing. Accordingly, in video encoding process, a technique for video encoding while maintaining higher level gray-scale information has become essential. For example, the international standard H.264/AVC is one of video encoding techniques enabling video encoding while maintaining higher level gray-scale.

First of all, the H.264/AVC encoding process will be described below.

The encoding process is a process for converting a raw image (input image) into a stream having a smaller amount of data. The H.264/AVC encoding process uses a prediction technique.

More particularly, the H.264 encoding process includes two main prediction methods: intra prediction and inter prediction. The intra prediction method includes a plurality of prediction modes with different block sizes and predicting directions (a block serves as a unit of prediction). The inter prediction method also includes a plurality of prediction modes with different block sizes. The H.264 encoding process achieves a high compression rate by dynamically selecting any one of the above-mentioned prediction methods according to the amount of coded bits.

The procedure for the H.264/AVC encoding process will be summarized below with reference to FIG. 6.

FIG. 6 illustrates an overview of processing by the H.264/AVC encoding process.

The encoding process using the intra prediction method selects intra prediction 20 by mode selection 40, and performs prediction 20, orthogonal transform 60, quantization 70, and variable length encoding 100 from a raw image 10 to obtain a stream 110. On the other hand, the encoding process using the inter prediction method selects inter prediction 30 by the mode selection 40, and performs the prediction 30, the orthogonal transform 60, the quantization 70, and the variable length encoding 100 from the raw image 10 to obtain the stream 110.

Each encoding process will be described in detail below.

The intra prediction 20 generates from the raw image 10 (input image) intra prediction information 220, an intra prediction image 130 as a prediction result, and an intra prediction error 200 representing a difference between the raw image 10 and the intra prediction image 130.

The inter prediction 30 receives the raw image 10 (input image) and a reference image 120 generated from past or future raw images, and generates inter prediction information 230, an inter prediction image 140, and an inter prediction error 210 representing a difference between the raw image 10 and the inter prediction image 140.

An encoding control section 50 determines a mode to be selected according to a mode selection algorithm based on the intra prediction error 200 input from the intra prediction 20, the inter prediction error 210 input from the inter prediction 30, and encoded information 160 input from the variable length encoding 100, and outputs mode selection information 190 to the mode selection 40. In general, the mode selection algorithm selects such a prediction method that involves a smaller amount of coded bits of the stream 110.

The mode selection 40 outputs the intra prediction image 130 (when the intra prediction 20 is selected) or the inter prediction image 140 (when the inter prediction 30 is selected) as a prediction image 150 based on the mode selection information 120 input from the encoding control section 50.

The orthogonal transform 60 generates a frequency component 240 through orthogonal transform processing based on an image 170 which is a difference between the raw image 10 and the prediction image 150.

The quantization 70 performs quantization process for the frequency component 240 to reduce the amount of information.

Inverse quantization 80 performs inverse quantization process for the quantized frequency component to generate a restored frequency component 250.

Inverse orthogonal transform 90 performs inverse orthogonal transform processing for the restored frequency component 250 to generate a restored differential image 180.

The restored differential image 180 and the prediction image 150 selected by the mode selection 40 are added and then stored as a reference image 120.

The variable length encoding 100 encodes the quantized frequency component and the intra prediction information 220 or the inter prediction information 230 into a bit string having a smaller amount of bits, outputs the encoded bit string as the stream 110, and outputs the encoded information 160 such as the amount of coded bits to the encoding control section 50.

Processing by the encoding control section 50 will be described below.

The encoding control section 50 determines a prediction mode to be selected using the mode selection algorithm based on the intra prediction error 200 output by the intra prediction 20, the inter prediction error 210 output by the inter prediction section 30, and the encoded information 160 output by the variable length encoding 100, and outputs the prediction mode as the mode selection information 120.

Since the mode selection algorithm largely affects the amount of coded bits and image quality of the stream 110 output by the video encoder, various types of mode selection algorithms are used depending on the content of the raw image 10 to be encoded and application for the video encoder.

The intra prediction error 200 and the inter prediction error 210 used for mode selection algorithms are used as an index representing how each of the intra prediction image 130 and the inter prediction image 140 resembles the raw image 10. In general, these errors are obtained in unit of block each being composed of several pixels vertically and horizontally which is a processing section for the encoding process.

Typical methods for calculating a prediction error between the raw image 10 and the intra prediction image 130 or between the raw image 10 and the inter prediction image 140 include the sum of absolute difference (SAD) and the sum of square difference (SSD).

When the raw image has a pixel value O and the prediction image predicted in the corresponding prediction mode i has a pixel value Pⁱ, the SAD and SSD can be calculated by the following formulas.

SADᵢ=Σ|O−Pⁱ|

SSDᵢ=Σ(O−Pⁱ)² Formula 1

where Σ represents that each of the pixel values O and Pⁱ is summed up for all pixels in a block.

The mode selection algorithm implemented in the encoding control section 50 largely affects the encoding efficiency. Therefore, there has been a demand (first demand) that the encoding control section 50 would be implemented by using a software-controllable general-purpose processor or digital signal processor to thereby change the mode selection algorithm according to the image characteristics and its application.

Further, there has been another demand (second demand) that an image would be encoded while maintaining higher level gray-scale information.

For the implementation of the encoding control section 50 by using a processor according to the first demand, the encoding control section 50 is connected with the intra prediction 20, the inter prediction 30, the variable length encoding 100, and the mode selection 40 via a general-purpose bus; therefore transmission bands are limited. More specifically, the general-purpose bus has a 16- or 32-bit bus width which generally is smaller than the number of bits required for the encoding process.

Further, the encoding control section 50 utilizes the intra prediction error 200, the inter prediction error 210, and the encoded information 160 to perform calculations for prediction mode determination in unit of block each being composed of several pixels vertically and horizontally which is a processing section for the encoding process. Therefore, in the encoding process for full HD images (1920×1080/60i) with a 16×16 pixel processing section, it is necessary to transmit the intra prediction error 200, the inter prediction error 210, the encoded information 160, and the mode selection information 120 via the general-purpose bus 243,000 times per second.

Among others, since this encoding process has characteristics that the amount of information of the intra prediction error 200 and the inter prediction error 210 increases with increasing amount of information of one pixel due to higher level gray-scale achievement, adopting the second demand will yield such an amount of information that it cannot be transmitted at one time via the general-purpose bus, thereby making it necessary to transmit it through a plurality of transmissions. Therefore, many transmission bands have been used only for prediction error transmission, resulting in a shortage in transmission bands for the encoding control section 50.

JP-A-8-289301 discloses a technique for thinning out block-unit image data used for prediction error calculation, i.e., reducing the calculation load in prediction mode determination through sampling, thus reducing the power consumption required for motion vector detection process.

As mentioned above, the technique disclosed in JP-A-8-289301 reduces the calculation load on the encoding control section by thinning out the pixel data used for prediction error calculation. Applying the sampling technique disclosed in JP-A-8-289301 to reduction in the amount of information of the intra prediction error and the inter prediction error can reduce the transmission load.

However, since this technique calculates a prediction error by thinning out pixel data, the accuracy of prediction error transmitted to the encoding control section decreases. Therefore mode selection with a high-precision prediction error is impossible and encoding efficiency is degraded disadvantageously.

The present invention has been devised in view of solving the above-mentioned problem. An object of the present invention is to provide a video encoder that evaluates a prediction error by using a prediction technique, capable of achieving high encoding efficiency without performance degradation by reducing the prediction error bit width without degrading the prediction error accuracy so much.

### SUMMARY OF THE INVENTION

A video encoder according to the present invention includes: an image encoding section for generating a prediction image from an input image and encoding the prediction image; and an encoding control device for evaluating an prediction error and selecting a prediction mode in prediction used by the image encoding section, wherein the encoding control device inputs from the image encoding section a prediction error having the prediction error bit width reduced to a predetermined bit width in each prediction mode to control prediction mode selection.

The image encoding section performs clipping of higher-order bits of the prediction error and reduction of lower-order bits thereof to reduce the prediction error bit width to the predetermined bit width, and outputs to the encoding control device the prediction error reduced to the predetermined bit width to select the prediction mode.

The encoding control device also sets to the image encoding section the number of higher-order bits to be clipped and the number of lower-order bits to be reduced. The image encoding section performs clipping of higher-order bits of the above-mentioned prediction error and reduction of lower-order bits thereof based on the number of higher-order bits to be clipped and the number of lower-order bits to be reduced, set by the encoding control device.

The predetermined bit width of the prediction error after bit width reduction is matched with the bus width used for prediction error transmission by the encoding control device and the image encoding section.

The above-mentioned configuration of the present invention enables providing a video encoder that evaluates a prediction error by using a prediction technique, capable of achieving high encoding efficiency without performance degradation by reducing the prediction error bit width without remarkably degrading the prediction error accuracy.

### BRIEF DESCRIPTION OF THE DRAWINGS

FIG. 1 illustrates an overall configuration of a video encoder according to an embodiment of the present invention.

FIG. 2 illustrates an internal configuration of an image encoding section 410.

FIG. 3 illustrates reduction of lower-order bits.

FIGS. 4A and 4B illustrate clipping of higher-order bits.

FIG. 5 illustrates a configuration of a prediction error normalization section 550.

FIG. 6 illustrates an overview of the H.264/AVC encoding process.

### DESCRIPTION OF THE PREFERRED EMBODIMENT

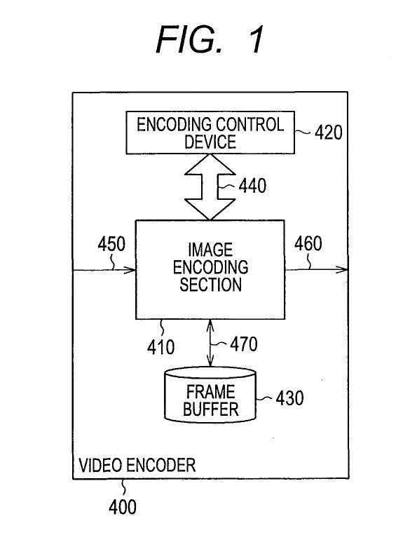

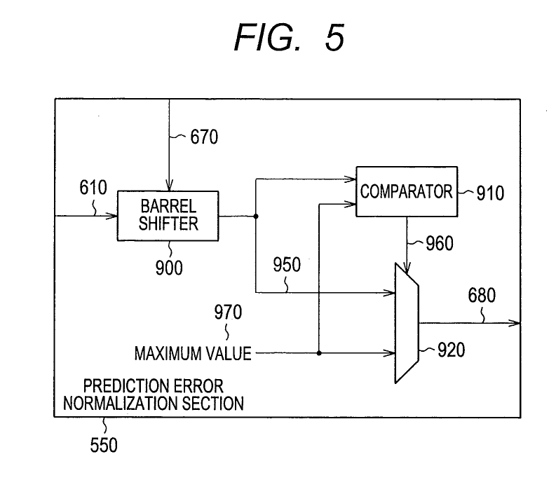

An embodiment according to the present invention will be described below with reference to FIG. 1 or 5.

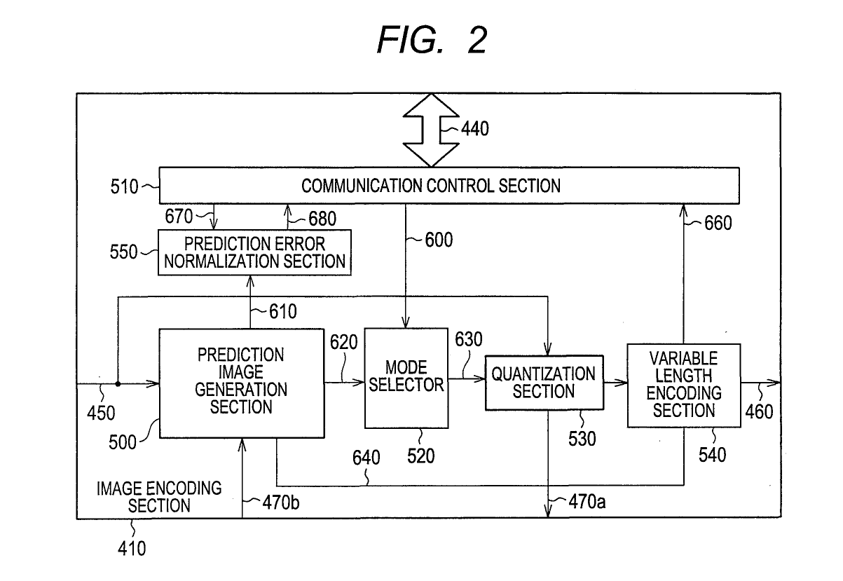

First of all, a configuration of a video encoder according to an embodiment of the present invention will be described below with reference to FIGS. 1 and 2.

FIG. 1 illustrates an overall configuration of the video encoder according to an embodiment of the present invention.

FIG. 2 illustrates an internal configuration of the image encoding section 410.

A video encoder 400 includes the image encoding section 410, an encoding control device 420, a general-purpose bus 440, and a frame buffer 430 as illustrated in FIG. 1.

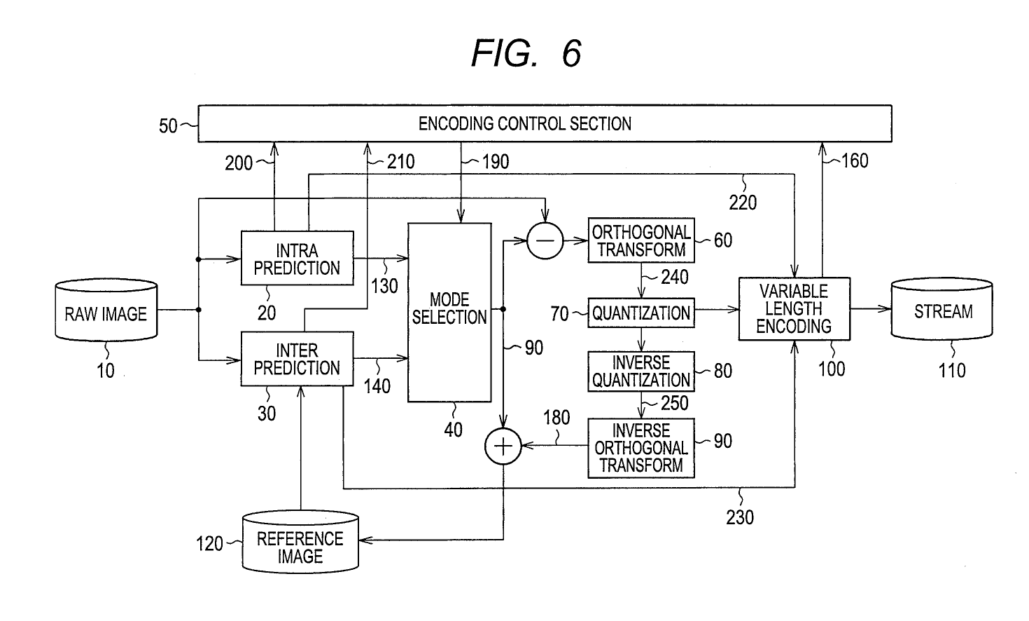

The image encoding section 410 performs intra prediction 20, inter prediction 30, mode selection 40, orthogonal transform 60, quantization 70, inverse quantization 80, inverse orthogonal transform 90, and variable length encoding 100, as the encoding processes illustrated in FIG. 6.

The encoding control device 420 performs processing of the encoding control section 50 included in the encoding processes illustrated in FIG. 6.

The encoding control device 420 is connected with the image encoding section 410 via the general-purpose bus 440 to transfer and receive to/from the image encoding section 410 the intra prediction error 200, the inter prediction error 210, the encoded information 160, and the mode selection information 120 which are provided in the encoding processes illustrated in FIG. 6.

The frame buffer 430 is used to store the reference image 120 of the encoding processes illustrated in FIG. 6.

A configuration and component operation of the image encoding section 410 will be described in detail below.

As illustrated in FIG. 2, the image encoding section 410 includes a prediction image generation section 500, a mode selector 520, a quantization section 530, a variable length encoding section 540, a communication control section 510, and a prediction error normalization section 550.

The prediction image generation section 500 performs the intra prediction 20 and the inter prediction 30 included in the encoding processes illustrated in FIG. 6, outputs a mode-specific prediction image 620 to the mode selector 520, and outputs a prediction error 610 between the mode-specific prediction image 620 and the raw image 450 to the prediction error normalization section 550 in each prediction mode. In the present embodiment, the SAD of the above-mentioned SAD and SSD will be used to obtain a prediction error. Further, the SAD is frequently used to obtain an actual prediction error since the SAD is more likely to provide a smaller evaluation value than the SSD.

The mode selector 520 performs processing of the mode selection 40 of the encoding processes illustrated in FIG. 6 and outputs the mode-specific prediction image 620 in the prediction mode selected by the mode prediction signal 600 as a prediction image 630.

The quantization section 540 performs processing of the orthogonal transform 60, the quantization 70, the inverse quantization 80, and the inverse orthogonal transform 90 which are provided in the encoding processes illustrated in FIG. 6.

The variable length encoding section 540 performs processing of the variable length encoding 540 of the encoding processes illustrated in FIG. 6.

The communication control section 510 controls the general-purpose bus 440 to mediate communication between the encoding control device 420 outside the image encoding section 410, and the prediction error normalization section 550, the variable length encoding section 540, and the mode selector 520 in the image encoding section 410.

The prediction error normalization section 550 reduces the amount of information for the prediction error 610 between the intra prediction 20 and the inter prediction 30 output from the prediction image generation section 500 to fit the bus width of the general-purpose bus 440 according to a normalization setting 670 input from the encoding control device 420 via the general-purpose bus 440 and the communication control section 510, and outputs the resultant prediction error as a normalized prediction error 680. The content of the normalization setting 670 will be described in detail below.

Processing by the communication control section 510 will be described below.

The communication control section 510 controls the general-purpose bus 440 to suitably output to the encoding control device 420 the normalized prediction error 680 input from the prediction error normalization section 550 of the image encoding section 410 and the encoded information 660 input from the variable length encoding section 540, holds in an internal register the normalization setting 670 and a mode selection signal 600 input from the encoding control device 420, and outputs them to the prediction error normalization section 550 and the mode selector 520.

The prediction error normalization section 550 performs normalization of the prediction error. The normalization of the prediction error refers to clipping higher-order bits and reducing lower-order bits of the prediction error to reduce the amount of information without degrading the prediction error accuracy.

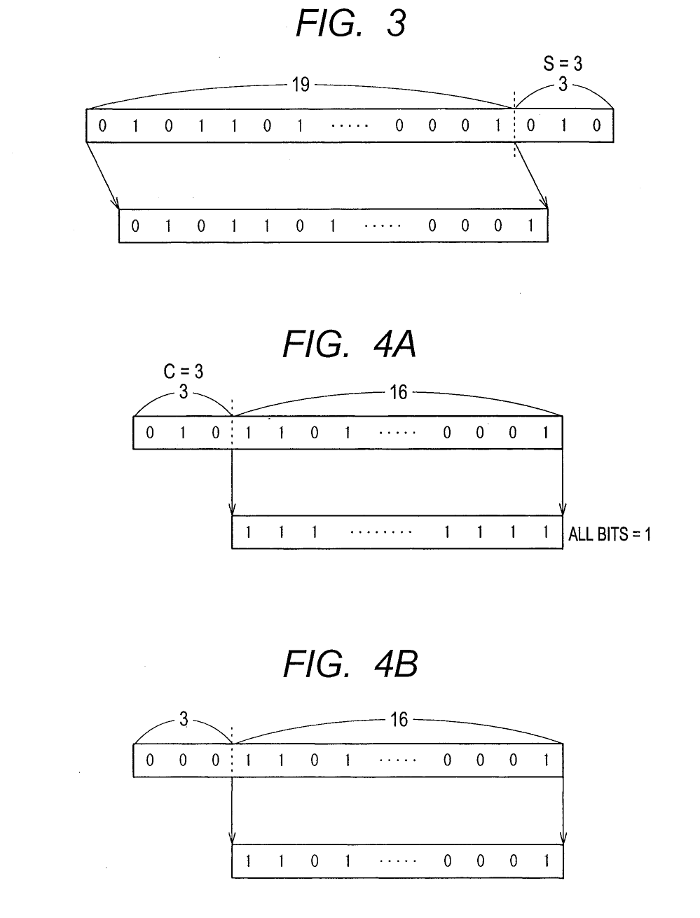

Prediction error normalization process will be described in detail below with reference to FIGS. 3 and 4.

FIG. 3 illustrates reduction of lower-order bits.

FIG. 4 illustrates clipping of higher-order bits.

For understanding of the meaning of reducing the amount of information through prediction error normalization process, how significant information is stored in which bit area of the SAD under what conditions will be described below, based on a case where a prediction error calculation method is implemented by the SAD.

A video encoding technique generates a prediction image by using a plurality of prediction modes such as intra prediction and inter prediction.

With an ordinary image having a small image change, a raw image resembles its prediction image.

In this case, because of a small difference between the raw and prediction images, significant information is stored in lower-order bits of the SAD but higher-order bits thereof are redundant because higher-order bits are constantly zero.

When prediction is not suitable because of, for example, a large scene change or screen transition, the raw image may be completely different from the prediction image.

In this case, the raw image is largely different from the prediction image. Therefore, the SAD gives a large value, and a significant value is stored in higher-order bits while lower-order bits representing a small value become less important.

Utilizing this characteristic can reduce the bit width of the SAD without missing significant information by suitably reducing higher-order and lower-order bits of the SAD according to the image.

In the present invention, the prediction error calculation method is not limited to the SAD or SDD as long as an index is given in such a manner as to take a small value in case of a small difference between the raw and prediction images and a large value in case of a large difference therebetween.

For example, suppose a case where the amount of information is reduced by the SSD represented by 22 bits. A target amount of reduction in the amount of information is an amount not exceeding the maximum value represented by the bus width used for prediction error transmission, via the general-purpose bus 440 in FIG. 1, by the encoding control device 420 and the image encoding section 410. The bus width normally is a fixed value. The maximum value represented by the bus width used for prediction error transmission by the encoding control device 420 and the image encoding section 410 is an amount not exceeding the maximum value represented by the bus width.

For example, when the general-purpose bus 440 has a 32-bit bus width, and a 16-bit width is assigned to normalized prediction error transmission, the maximum value of the bus width usable for normalized prediction error transmission equals the maximum value represented by 16 bits, i.e., 65535 (hexadecimal number 0xffff).

In this example, since the SSD is represented by 22 bits, 6 bits needs to be reduced. In reducing the amount of information of prediction error, reduction of higher-order bits is achieved by clipping higher-order bits, and reduction of lower-order bits is achieved by shifting bits toward lower-order bits. The normalization setting 670 represents the extent of clipping higher-order bits and reducing lower-order bits and has a format (c, s), where c denotes the number of higher-order bits subjected to clipping and s denotes the number of bits shifted toward lower-order bits.

In this example, since a 6-bit width is reduced, (c, s) may be, for example, (3, 3) or (4, 2) so that c+s equals 6.

Here, suppose that normalization setting is made with (3, 3).

First, as illustrated in FIG. 3, bits are shifted toward lower-order bits by s=3 bits.

As illustrated in FIG. 4A, when any one of c higher-order bits is set to 1, all bits below the c higher-order bits are set to 1 for use as a value after clipping. As illustrated in FIG. 4B, when all of c higher-order bits are set to 0, all bits below the c higher-order bits are left unchanged for use as a value after clipping.

Clipping process reduces higher-order bits in this way in order to represent the nearest possible value only with lower-order bits. More specifically, any one of c higher-order bits are set to 1, all bits below the c higher-order bits are set to 1. This means approximation by a maximum value that can be represented by lower-order bits.

In this case, when the 16-bit bit width is assigned to normalized prediction error transmission, the resultant value coincides with a maximum value that can be represented by 16 bits, i.e., 65535.

Processing by the prediction error normalization section 550 will be described below.

A configuration and component operation of the prediction error normalization section 550 will be described below with reference to FIG. 5.

FIG. 5 illustrates a configuration of the prediction error normalization section 550.

The prediction error normalization section 550 performs the above-mentioned prediction error normalization process.

The prediction error normalization section 550 receives the prediction error 610, and performs reduction of lower-order bits and clipping of higher-order bits as specified by the normalization setting 670.

The prediction error normalization section 550 includes a barrel shifter 900, a comparator 910, and a selector 920.

When the normalization setting 670 is (c, s), the barrel shifter 900 shifts the bits of the SAD input as the prediction error 610 by s bits toward lower-order bits, and outputs the resultant value as a prediction error 950 with shifted lower-order bits.

The comparator 910 receives the prediction error 950 with shifted lower-order bits, compares it with a maximum value 970 (value after normalization with all bits set to 1), and outputs the maximum value 970 to the selector 920 when the prediction error 950 is larger than the maximum value (when any one of the c higher-order bits is set to 1) or a selection signal 960 for selecting the prediction error 680 with shifted lower-order bits as it is otherwise (when all of the c higher-order bits are set to 0).

In response to the selection signal 960 input from the comparator 910, the selector 920 outputs, as the normalized prediction error 680, the maximum value 970 or the bit width assigned to the general-purpose bus 440 for normalized prediction error transmission from lower-order bits side of the prediction error 950 with shifted lower-order bits.

To achieve prediction error normalization process according to the present invention, the configuration of the prediction error normalization section 550 is not limited to the present embodiment as long as clipping of upper-order bits and reduction of lower-order bits are accomplished.

Meanwhile, the normalized prediction error 680 has a feature in becoming equal to the maximum value 970 of the normalized prediction error 680 when the prediction errors 610 before normalization is equal to or larger than the maximum value 970.

Therefore, when the value of the normalized prediction error 680 equals the maximum value 970, the prediction mode determination algorithm using the normalized prediction error 680 determines that the image quality in the prediction mode is extremely inferior and therefore excludes the relevant mode from candidates for prediction mode determination.

If the normalized prediction error 680 equals the maximum value 970 in all prediction modes, extremely inferior image quality results in any prediction mode. In this case, the prediction mode determination algorithm determines that there is no remarkable difference in subjective image quality and therefore selects a predetermined prediction mode.

In the present embodiment, the predetermined mode is set to the side of the inter prediction 30 since this generates a smaller amount of codes than the intra prediction 20.

In the present invention setting, the predetermined mode is not limited to the inter prediction 30 but may be a suitable prediction mode according to application and object.

As mentioned above, the optimal amounts of higher-order and lower-order bits of the SAD depend on the image.

In the case of an ordinary image having small image changes, higher-order bits of the SAD are redundant and therefore it is desirable to reduce the amount of information of higher-order bits (to increase c and decrease s).

In the case of an image having a large scene change or screen transition, a significant SAD value area exists on higher-order bits side and therefore it is desirable to reduce the amount of information of lower-order bits (to decrease c and increase s).

Therefore, before image picture processing is started, the encoding control device 420 predicts the degree of screen change based on the normalized prediction error 680 and the encoded information 660 of the previous picture, and outputs the normalization setting 670 according to the amount of presumption to the communication control section 510 via the general-purpose bus 440.

The communication control section 510 latches the normalization setting 670 input from the encoding control device 420 at the image picture processing start timing, and outputs it to the prediction error normalization section 550.

The number of times of calculation required for deriving the normalization setting 670 is only one for each picture, thus resulting in the encoding control device 420 having a sufficiently low calculation load.

Although the target amount of reduction in the amount of information is an amount not exceeding the maximum value of the bus width usable by the normalized prediction error, i.e., the maximum value 970 in the above-mentioned example, another scale may be used.

For example, as a target of the amount of reduction in the amount of information, when the encoding control device 420 is implemented by a central processing section (CPU) or a dedicated processor, the maximum value 970 is a maximum value that can be represented by a register. Thus, when the normalization process is implemented by software, processing for a prediction error can be done by one instruction. Therefore, the improvement in throughput of processing for prediction error can be expected by subjecting a prediction error to such normalization process.

What is claimed is:

1. A video encoder for encoding a moving image, comprising:
an image encoding section configured to generate a prediction image from an input image and encode the prediction image; and
an encoding control device configured to evaluate the prediction error and select a prediction mode in prediction used by the image encoding section,
wherein the image encoding section performs clipping of higher-order bits of the prediction error and reduction of lower-order bits thereof to reduce the prediction error bit width to a predetermined bit width, and outputs to the encoding control device the prediction error reduced to the predetermined bit width to select a prediction mode.

2. The video encoder according to claim 1,
wherein the encoding control device sets to the image encoding section the number of higher-order bits to be clipped and the number of lower-order bits to be reduced, and
wherein the image encoding section performs clipping of higher-order bits of the prediction error and reduction of lower-order bits thereof based on the number of higher-order bits to be clipped and the number of lower-order bits to be reduced, set by the encoding control device.

3. The video encoder according to claim 2,
wherein, in case of a large value of the prediction error, the encoding control device sets a small number of higher-order bits to be clipped and a large number of lower-order bits to be reduced, and
wherein, in case of a small value of the prediction error, the encoding control device sets a large number of higher-order bits to be clipped and a small number of lower-order bits to be reduced.

4. The video encoder according to claim 1,
wherein the predetermined bit width of the prediction error after bit width reduction is matched with the bus width used for prediction error transmission by the encoding control device and the image encoding section.

5. The video encoder according to claim 1,
wherein the predetermined bit width of the prediction error after bit width reduction is the bit width of a register of the encoding control device.

6. The video encoder according to claim 1,
wherein, when the value of the prediction error with reduced bit width input from the image encoding section for each of the prediction modes is a predetermined maximum value, the encoding control device excludes the prediction mode from candidates for prediction mode selection and then selects a prediction mode.

7. The video encoder according to claim 6,
wherein, when the value of the prediction error with reduced bit width input from the image encoding section for each of the prediction modes is a predetermined maximum value in all prediction modes, the encoding control device selects a predetermined prediction mode.

8. The video encoder according to claim 1,
wherein the prediction error is calculated from a difference between a plurality of pixels and serves as an index having a small value in case of a small difference between the input and prediction images and having a large value in case of a large difference therebetween.

9. A data processing method for a video encoder for encoding a moving image, the data processing method comprising:
generating a prediction image from an input image and encoding the prediction image;
evaluating the prediction error and selecting a prediction mode in prediction used by the image encoding section;
performing clipping of higher-order bits of the prediction error and reduction of lower-order bits thereof to reduce the prediction error bit width to a predetermined bit width; and
outputting the prediction mode with the bit width reduced to the predetermined bit width so as to select the prediction mode.

10. The data processing method for a video encoder according to claim 9, further comprising:
setting the number of higher-order bits to be clipped and the number of lower-order bits to be reduced; and
performing, in reducing the prediction error bit width to a predetermined bit width, clipping of higher-order bits of the prediction error and reduction of lower-order bits thereof based on the set number of higher-order bits to be clipped and the set number of lower-order bits to be reduced.

11. The data processing method for a video encoder according to claim 10,
wherein, in case of a large value of the prediction error, the encoding control device sets a small number of higher-order bits to be clipped and a large number of lower-order bits to be reduced, and
wherein, in case of a small value of the prediction error, the encoding control device sets a large number of higher-order bits to be clipped and a small number of lower-order bits to be reduced.

12. The data processing method for a video encoder, according to claim 9,
wherein the predetermined bit width of the prediction error after bit width reduction is matched with the bus width used for prediction error transmission by the encoding control device and the image encoding section.

13. The data processing method for a video encoder, according to claim 9,
wherein the predetermined bit width of the prediction error after bit width reduction is matched with the bit width of the register of the encoding control device.

14. The data processing method for a video encoder, according to claim 9,
wherein, when the value of the prediction error with reduced bit width input from the image encoding section for each of the prediction modes is a predetermined maximum value, the encoding control device excludes the prediction mode from candidates for prediction mode selection and then selects a prediction mode.

15. The data processing method for a video encoder, according to claim 14,
wherein, when the value of the prediction error with reduced bit width input from the image encoding section for each of the prediction modes is a predetermined maximum value in all prediction modes, the encoding control device selects a predetermined prediction mode.

16. The data processing method for a video encoder according to claim 9,
wherein the prediction error is calculated from a difference between a plurality of pixels and serves as an index having a small value in case of a small difference between the input and prediction images and having a large value in case of a large difference therebetween.
